(19) United States
(12) Patent Application Publication
(10) Pub. No.: US 2008/0152290 A1
(43) Pub. Date: Jun. 26, 2008

(54) FIBER DISTRIBUTION HUB ASSEMBLY

(75) Inventors: Ludwig C. Graff, Ellicott City, MD (US); Vijay Jain, Columbia, MD (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Corp., Arlington, VA (US)

(21) Appl. No.: 11/615,533

(22) Filed: Dec. 22, 2006

(51) Int. Cl. G02B 6/44

(52) U.S. Cl. 385/135

(57) ABSTRACT

A fiber distribution hub assembly is provided. The assembly may include a housing, one or more optical splitter devices, and an optical patch panel. The housing may define an interior area for storing the optical splitter devices and the optical patch panel. The optical splitter device is configured to receive an input optical fiber carrying an optical signal and split the optical signal among multiple output optical fibers. The optical patch panel includes a plurality of LC adapters that are in communication with distribution cables leading to different elements of a network. The LC adapters of the optical patch panel are configured to receive LC plugs attached to the ends of output optical fibers. A particular optical signal can be sent to a particular element of the network by connecting the appropriate output optical fiber to the LC adapter in communication with that element via a respective distribution cable.

### BACKGROUND INFORMATION

A fiber distribution hub assembly may be part of a fiber optical network. In general, a fiber distribution hub assembly includes an optical splitter device for receiving and splitting an optical signal into multiple optical signals and an optical patch panel for connecting and/or directing the multiple optical signals to the intended destination elements of the fiber optical network. Typically the optical patch panel includes multiple adapters that are in communication with distribution cables of the network. The adapters are configured to receive an output optical fiber extending from the optical splitter device and carrying the split optical signal. For example, some known optical patch panels include a plurality of SC-type adapters configured to receive SC-type plugs attached to the ends of the output optical fibers. Each adapter is connected to a particular destination element of the network. Consequently, the split optical signal can be directed to a particular destination element be engaging an output optical fiber into the adapter in communication with that particular destination element.

In general, the more adapters within an optical patch panel, the more destination elements that may be connectable through the fiber distribution hub assembly. However, adding adapters to the optical patch panel may add to the overall size of the optical patch panel and thus the overall size of the fiber distribution hub assembly.

Fiber distribution hub assemblies may be located and mounted in various areas. For example, a fiber distribution hub assembly may be mounted to a telephone pole or a building or may be stored within a building. In many locations, it may be desirable to minimize the overall size of the fiber distribution hub assembly for storage and aesthetic purposes.

### BRIEF DESCRIPTION OF THE SEVERAL VIEWS OF THE DRAWING(S)

FIG. 1 is a block diagram of an optical fiber network consistent with exemplary embodiments;

FIG. 2 is a block diagram of a fiber distribution hub according to an exemplary embodiment;

FIG. 3 is a block diagram of a LC adapter according to an exemplary embodiment; and

FIG. 4 is a block diagram of a LC plug according to an exemplary embodiment.

### DETAILED DESCRIPTION OF PREFERRED EMBODIMENTS

Exemplary embodiments are described hereinafter with reference to the accompanying drawings, in which exemplary embodiments and examples are shown. Like numbers refer to like elements throughout.

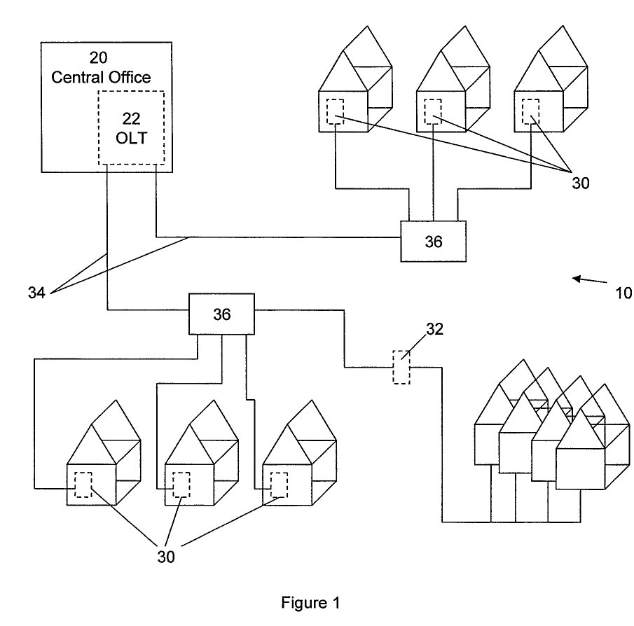

A fiber distribution hub assembly may operate within or be part of an optical fiber network. For example, the fiber distribution hub assembly described herein may be part of a fiber to the premises (FTTP), also referred to as fiber to the home (FTTH), system using passive optical networks. Referring to FIG. 1, a FTTP system may include or otherwise be in communication with a provider's central office 20 that delivers optical signals to a plurality of subscribers through a passive optical network or PON 10. The passive optical network may 10 include an optical line terminal (OLT) 22 at the provider's central office and a plurality of optical network terminals (ONTs) 30 located at the premises of the subscribers, e.g. a customer home. The passive optical network may also include one or more optical network units (ONUs) 32 that function as gateways to additional sub-networks associated with other systems, such as fiber to the curb (FTTC) and fiber to the neighborhood (FTTN) systems. The OLT 22 can be connected to the ONTs 30 and ONUs 32 through a series of fiber links 34 and one or more fiber distribution hub assemblies 36.

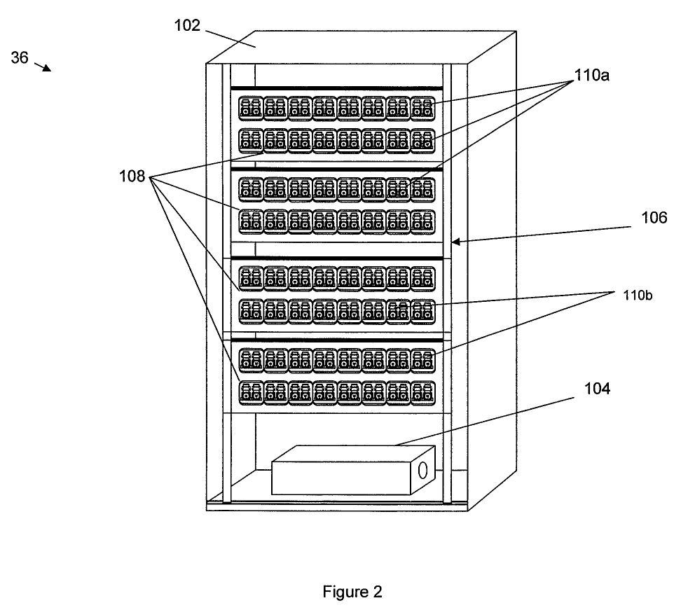

Referring to FIG. 2, a fiber distribution hub assembly 36 may include a housing 102, at least one optical splitter device 104, and an optical patch panel 106. The housing 102 may define an interior area for storing and supporting the optical splitter device 104 and the optical patch panel 106. As further described below, the optical splitter device 104 is configured to receive an input optical fiber carrying an optical signal and split the optical signal among a plurality of output optical fibers. The optical patch panel 106 includes a first plurality of adapters 110a that are in communication with distribution cables leading to the ONTs or OLTs. The adapters 110a of the optical patch panel are configured to receive the output optical fibers. Consequently, a particular optical signal can be sent to a particular ONT or OLT by connecting the appropriate output optical fiber to the input adapter in communication with that ONT or OLT via a respective distribution cable.

The housing 102 may include one or more shelf structures for supporting the optical splitter device or devices 104. The housing 102 may also include support members for supporting the optical patch panel 106. In addition to supporting the optical splitter devices 104 and the optical patch panel 106, the housing 102 may also provide a complete enclosure for the optical splitter devices 104 and the optical patch panel 106. A complete enclosure may be configured to protect the optical splitter devices 104 and the optical patch panel 106 from the environment and/or vandals. Access to the interior of the housing 102 may be provided through panels or doors defined by the housing 102. The panels or doors may include locking devices to control access to the interior of the housing 102 to only authorized technicians or users. The housing 102 may also define a number of openings for a number of fiber optical cables extending to and from the optical splitter devices 104 and the optical patch panel 106. The housing 102 may also be configured to be mounted to another structure such as a telephone pole or the side of the building.

Each optical splitter device 104 is configured to receive an input optical fiber carrying an optical signal and split the optical signal among a plurality of output optical fibers. U.S. patent application (Attorney Docket No. 20060275), entitled as Optical Splitter Assembly, assigned to the same assignee as the present application, and filed the same day as the present application, discloses optical splitter devices or assemblies that are consistent with exemplary embodiments of the present application, as such U.S. patent (Attorney Docket No. 2006275) is hereby incorporated by reference in its entirety.

The optical patch panel 106 may include at least one panel section 108, also referred to as a shelf. Each panel section 108 may be attached to the support members of the housing and define a plurality of openings. The openings are configured to receive and/or support adapters 110 (e.g., 110a and 110b). Each adapter 110 defines at least one opening or orifice for receiving at least a portion of an output fiber extending from an optical splitter assembly 104. In particular, an end of the output fiber is connectorized, such that a plug is attached to the output fiber and the plug is configured to fit into an orifice of an adapter 110 of the optical patch panel. An orifice of an adapter 110a may be in communication with a distribution cable such that when the plug of the output fiber is connected to the orifice of the adapter 110a, the optical signal carried on the output fiber travels from the output fiber through the plug and the orifice of the adapter 110a to the distribution cable.

In addition to the adapters in communication with distribution cables (referred to herein as distribution adapters 110a), the fiber distribution hub assembly 36 may include one or more adapters for storage (referred to herein as storage adapters 110b). In particular, one or more adapters 110b may have one or more orifices that are not in communication with a distribution cable. These adapters 110b, or more particularly the orifices of these adapters, provide a storage or parking space for one or more output fibers. For example, if there are more output fibers than homes or other premises that are configured to or need to receive the output signals carried on the output fibers, the plugs of the excess output fibers may be stored into one of the storage adapters 110b.

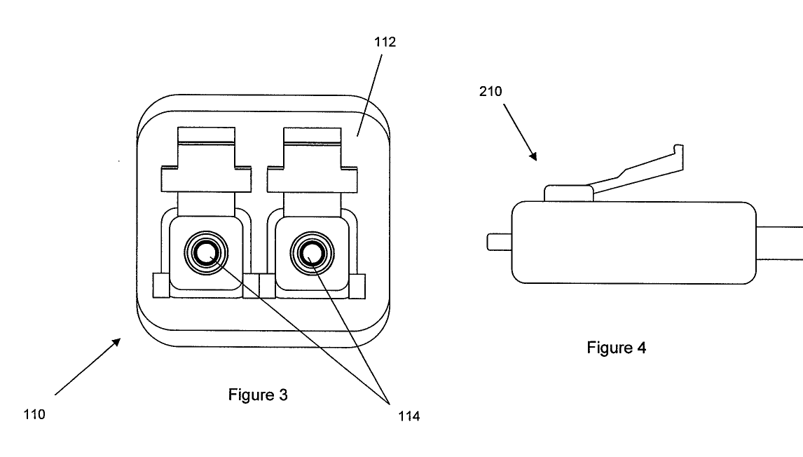

Referring to FIG. 3, one or more of the adapters 110 and plugs 210 form one or more LC type connection, i.e. the adapter is a LC adapter and the plug is a LC plug. LC type connectors are further described in ANSI/TIA/EIA-604-10A02002 (Approved Mar. 6, 2002) Standard for “Fiber Optic Connector Intermateability Standard-Type LC” which is hereby incorporated by reference in its entirety. As shown in FIG. 3, each LC adapter 110 may have one housing 112 and two orifices 114. Therefore each LC adapter is configured to receive two plugs. Moreover, the width of a LC adapter is around 13.5 mm and the height is around 10 mm, which are approximately the same dimensions as a SC adapter. Because a LC adapter is configured to receive two plugs within an area that is relatively the same size of a SC plug, which is only configured to receive one plug, a LC adapter 110 of exemplary embodiments generally has one-half the form factor as a SC adapter.

Referring again to FIG. 2, each panel section 108 may include a plurality of LC adapters 110. For example, according to the exemplary embodiment illustrated in FIG. 2, the optical patch panel 106 includes four panel sections 108, wherein each panel section includes a plurality of LC adapters 110. In this embodiment, two of the panel sections 108 include distribution LC adapters 110a and two of the panel sections 108 include storage LC adapters 110b. It is understood that FIG. 2 is only an example, the number of panel sections and the ratio of distribution to storage LC adapters 110a, 110b may vary. Also, a panel section 108 may include both distribution and storage LC adapters 110a, 100b or a panel section may include only distribution LC adapters 110a or only storage LC adapters 110b

Again referring to FIG. 2, each panel section 108 may include at least one row of a plurality of LC adapters 110. The LC adapters 110 may be closely spaced to each other relative to a width of a LC adapter, i.e., the distance between adjacent LC adapters 110 may be equal to or smaller than the width of an individual LC adapter 110. As an example, the spacing around adjacent LC adapters may be approximately 7.2 mm. The LC adapters 110 may extend substantially across a width of each panel section 108 in multiple rows. The closely spaced LC adapters 110 and multiple rows, along with the relatively small form factor of the LC adapters 110, allow for more adapters per optical panel section 108 than an optical panel section having SC adapters, which in turn may reduce the overall size of the fiber distribution hub assembly, while providing a plurality of adapters. As an example, an optical patch panel may include a plurality of distribution LC adapters 110a comprising six rows, wherein each row includes 24 LC adapters. The optical patch panel may also include a plurality of storage adapters 110b comprising six rows, wherein each row includes 24 LC adapters. Thus in this example, the optical patch panel includes 288 distribution LC adapters and 288 storage LC adapters.

According to one exemplary embodiment, an assembly is provided. The assembly may comprise an optical patch panel having at least one patch panel section. Each patch panel section may include a plurality of LC adapters. And the distance between adjacent LC adapters may be equal to or less than a width of an LC adapter. The plurality of LC adapters may also extend substantially across a width of the optical patch panel in a plurality of rows

The assembly may further comprise one or more optical splitter devices. Each optical splitter device may be configured to receive an input optical fiber carrying an optical signal and split the optical signal into a plurality of optical signals that are carried through a plurality of output optical fibers in communication with the optical splitter device.

The assembly may also include a plurality of LC plugs. Each LC plug may be attached to an end of one of the output optical fibers in communication with one of the optical splitter devices and be configured to connect to one of the plurality of LC adapters.

The assembly may include a housing defining an interior area for storing the optical patch panel and the one or more optical splitter devices.

In the preceding specification, various embodiments of the claimed invention have been described. It will, however, be evident that various modifications and changes may be made thereunto without departing from the broader spirit and scope of the invention as set forth in the claims that follow. The specification and drawings are accordingly to be regarded in an illustrative rather than restrictive sense.

1-10. (canceled)

11. An assembly comprising:
a housing;
at least one optical splitter device configured to receive an input optical fiber carrying an optical signal and split the optical signal into a plurality of optical signals, each one of said signals being carried through a different one of a like plurality of output optical fibers in communication with the at least one optical splitter device;
a like plurality of LC plugs, wherein a different one of the plurality of LC plugs is attached, respectively, to an end of a different one of the plurality of output optical fibers, said different one of the plurality of LC plugs being configured to connect to an LC adapter; and
an optical patch panel having at least a first plurality of LC adapters and a second plurality of LC adapters, wherein each of the first plurality of LC adapters is in communication with a distribution cable and each of the second plurality of LC adapters is not in communication with a distribution cable such that each of the first plurality of LC adapters is for receiving an LC plug and passing through the optical signal carried on the output optical fiber attached to the LC plug to a distribution cable in communication with the LC plug and each of the second plurality of LC adapters is for storing an LC plug;
wherein the second plurality of LC adapters includes an LC adapter for each of the first plurality of LC adapters.

12. (canceled)

13. The assembly according to claim 11 wherein a distance between adjacent LC adapters of the first plurality of LC adapters is equal to or less than a width of an LC adapter and a distance between adjacent LC adapters of the second plurality of LC adapters is equal to or less than a width of an LC adapter.

14. The assembly according to claim 11, wherein the optical patch panel includes at least a first optical patch panel section and a second optical patch panel section, and wherein the first optical patch panel section includes the first plurality of LC adapters extending substantially across a width of the first optical patch panel section and the second optical patch panel section includes the second plurality of LC adapters extending substantially across a width of the second optical patch panel section.

15. The assembly according to claim 14, wherein the first plurality of LC adapters extends substantially across the width of the first optical patch panel section in a plurality of rows and the second plurality of LC adapters extends substantially across the width of the second optical patch panel section in a plurality of rows.

16. An assembly comprising:
a housing;
at least one optical splitter device configured to receive an input optical fiber carrying an optical signal and split the optical signal into a plurality of optical signals, each one of said signals being carried through a different one of a like plurality of output optical fibers in communication with the at least one optical splitter device;
an optical patch panel having at least one patch panel section, wherein the at least one patch panel section includes a plurality of LC adapters, and wherein a distance between adjacent LC adapters is equal to or less than a width of an LC adapter; and
a like plurality of LC plugs, wherein a different one of the like plurality of LC plugs is attached, respectively, to an end of a different one of the plurality of output optical fibers, said different one of the plurality of LC plugs being configured to connect to one of the plurality of LC adapters of the at least one patch panel section;
wherein the plurality of LC adapters includes at least one LC adapter in communication with a distribution cable for receiving an LC plug and passing through the optical signal carried on the output optical fiber attached to the LC plug to the distribution cable and at least one LC adapter not in communication with a distribution cable for receiving and storing an LC plug; wherein for each LC adapter connected to a distribution cable is an LC adapter not connected to a distribution cable.

17. The assembly according to claim 16, wherein the plurality of LC adapters of the at least one optical patch panel section extend substantially across a width of the at least one optical patch panel section in a plurality of rows.
